(19) United States
(12) Patent Application Publication
(10) Pub. No.: US 2007/0187118 A1
(43) Pub. Date: Aug. 16, 2007

(54) Vehicle implement attachment system

(75) Inventor: Jeannot Belanger, Granby (CA)

Correspondence Address: OSLER, HOSKIN & HARCOURT LLP (BRP), 2100 - 1000 DE LA GAUCHETIERE ST. WEST, MONTREAL, H3B4W5, CA

(73) Assignee: Bombardier Recreational Products Inc., Valcourt (CA)

(21) Appl. No.: 11/352,325

(22) Filed: Feb. 13, 2006

(51) Int. Cl. A01B 79/00

(52) U.S. Cl. 172/1

(57) ABSTRACT

A vehicle implement attachment assembly has a frame, a spring loaded stand assembly, a first portion of a lock at one end of the frame, and a utility attachment at the other end of the frame. The stand assembly supports the end of the frame having the first portion of the lock thereon, such that the first portion of the lock at least as high as a second portion of the lock located on a vehicle. When the vehicle is moved towards the vehicle implement, it pushes down on the end of the frame having the first portion of the lock thereon to properly align the first and second portions of the lock so that they can be engaged. The lock is then locked and the vehicle implement can be used with the vehicle.

### FIELD OF THE INVENTION

The present invention relates to a vehicle implement attachment system and a method for attaching a vehicle implement to a vehicle.

### BACKGROUND OF THE INVENTION

It is well known that accessories can be added to a vehicle to give it additional utility or convenience. One such accessory is a vehicle implement having a utility attachment, such as a plow, at the end thereof which permits the vehicle to do more utilitarian tasks. Vehicle implements are often used with all-terrain vehicles (ATVs), trucks, and tractors.

Most current vehicle implements are attached to the vehicle by passing a pin or bolt through holes found in a bracket on the vehicle and in the vehicle implement. Although this provides a secure attachment, it requires a user to manually align multiple holes which can be difficult considering the weight of some vehicle implements. This can become even more difficult when there are multiple attachment points. This type of attachment may also require the use of tools to properly secure the vehicle implement. This means that the tools need to be carried in the vehicle or that the vehicle implement can only be attached and removed at a service area, neither of which is very convenient. Also, the pins or bolts may be lost if a user is not careful.

One solution to these problems is illustrated in U.S. Pat. No. 6,145,222 (the '222 patent). The '222 patent illustrates a snow plow mounted to a frame for attachment to a four-wheel drive vehicle. The frame is provided with a hydraulic jack assembly which allows a user to hydraulically raise or lower the frame in order to align it with a receiver plate on the vehicle. Once properly aligned, the vehicle is moved forward and the frame is attached to the vehicle. However, since the user needs to visually align the frame and the receiver plate, the frame may be misaligned with the receiver plate which would require the user to back up the vehicle and start again. Also, the hydraulic system adds substantial costs for vehicle implements that do not already use such a system for the utility attachment. Hydraulic systems also add complexity and require substantial maintenance.

Thus, there exists a need to provide a vehicle implement attachment system that allows a vehicle implement to be more easily attached to a vehicle.

### SUMMARY OF THE INVENTION

It is an object of the present invention to provide a vehicle implement that can be more easily attached to a vehicle.

It is a further object of the present invention to provide a vehicle implement which simplifies the alignment of a vehicle implement frame with a vehicle.

It is yet another object of the present invention to provide a quick locking mechanism for attaching a vehicle implement to a vehicle.

It is an additional object of the present invention to provide a simple method of attaching a vehicle implement to a vehicle.

Embodiments of the present invention will preferably, although not necessarily, meet more than one of the above noted objects.

In one aspect, the invention provides a vehicle implement attachment assembly for attaching a vehicle implement to a vehicle. The assembly has a frame. The frame has a first end and a second end. The first end is constructed and arranged to cooperate with a utility attachment. A lock is provided and has a first portion and a second portion. The first portion of the lock is operatively connected to the second end. The first portion of the lock is constructed and arranged to cooperate with the second portion of the lock on the vehicle. A stand assembly disposed on the frame, for supporting the frame for supporting the frame at a variable height above the ground when the utility attachment is attached to the frame. The height of the stand assembly diminishing at least in response to movement of the vehicle to a vehicle implement engagement position.

In another aspect, the invention provides a vehicle implement attachment assembly for attaching a vehicle implement to a vehicle. The assembly has a frame. The frame has a first end and a second end. The first end constructed and arranged to cooperate with a utility attachment. A lock is provide and has a first portion and a second portion. A first portion of the lock is operatively connected to the second end. The first portion of the lock is constructed and arranged to cooperate with the second portion of the lock on the vehicle. A stand assembly is operatively connected to the frame. The stand assembly is moveable between a first position supporting the frame and a second position where the stand assembly is stowed away. The stand assembly is operatively connected to the first portion of the lock such that moving the stand assembly to the first position unlocks the lock and moving the stand assembly to the second position locks the lock.

In a further aspect, the invention provides a method for attaching a vehicle implement to a vehicle. The vehicle implement has a frame having a first end and a second end; a utility attachment operatively connected to the first end; a first portion of a lock operatively connected to the second end; and a stand assembly operatively connected to the frame for supporting the frame when the vehicle implement rests on the ground when the stand assembly is in a first position. The vehicle has a bracket attached to a portion thereof, and a second portion of the lock is attached to the bracket. The first step of the method consists in adjusting the height of the stand assembly when the stand assembly is in the first position, such that the first portion of the lock is at least as high above the ground as the second portion of the lock. Then, the vehicle is moved to a vehicle implement engagement position. Then, the first portion of the lock is vertically aligned with the second portion of the lock by causing the vehicle to lower the second end of the frame as the vehicle moves into the vehicle implement engagement position. Finally, the lock is locked.

It should be noted that some embodiments of the present invention may cover more than one aspect of this invention.

### BRIEF DESCRIPTION OF THE DRAWINGS

The foregoing and other advantages of the invention will become apparent upon reading the following detailed description and upon reference to the drawings in which:

FIG. 1A is a left side elevation view of an ATV to which the vehicle implement of the present invention can be attached;

FIG. 1B is a left side view of the front portion of an ATV with the vehicle implement of the present invention attached thereto;

FIG. 2 is a bottom plan view of a front portion of a frame of the ATV of FIG. 1A;

FIG. 3 is a left side elevation view of a vehicle implement having a first embodiment of a vehicle implement attachment system of the present invention;

FIG. 4 is a top plan view of the vehicle implement of FIG. 3;

FIG. 5 is a perspective view, taken from a rear, left side, of the vehicle implement of FIG. 3;

FIG. 6 is a close-up view of a first portions of locks of the vehicle implement of FIG. 3;

FIG. 7 is a close-up view of both the first portions of the locks of the vehicle implement of FIG. 3 and the second portions of the locks on the vehicle in a vehicle implement engagement position, with the locks in a locked position;

FIG. 8 is a left side elevation view of a vehicle implement having a second embodiment of a vehicle implement attachment system of the present invention with the locking mechanism in an unlocked position;

FIG. 9 is a top plan view of the vehicle implement of FIG. 8;

FIG. 10 is a perspective view, taken from a rear, left side, of the vehicle implement of FIG. 8;

FIG. 11 is a perspective view, taken from a rear, right side, of the frame of the vehicle implement of FIG. 8;

FIG. 12 is a cross-sectional view of the stand assembly and a portion of the frame taken through line A-A of FIG. 8;

FIG. 13 is a left side elevation view of a vehicle implement having the second embodiment of the vehicle implement attachment system of the present invention with the locking mechanism in an locked position;

FIG. 14 is a top plan view of the vehicle implement of FIG. 13;

FIG. 15 is a perspective view, taken from a rear, left side, of the vehicle implement of FIG. 13;

FIG. 16 is a perspective view, taken from a rear, right side, of the frame of the vehicle implement of FIG. 13;

FIG. 17 is a cross-sectional view taken through line B-B of FIG. 8 with the second portions of the locks of the vehicle in a vehicle implement engagement position with the lock in an unlocked position;

FIG. 18 is a close-up view of both the first portion of the lock of the vehicle implement attachment system of the second embodiment of the present invention and the second portion of the lock of the vehicle in a vehicle implement engagement position, with the lock in an unlocked position;

FIG. 19 is a close-up view of both the first portion of the lock of the vehicle implement attachment system of the second embodiment of the present invention and the second portion of the lock of the vehicle in a vehicle implement engagement position, with the lock in a locked position; and

FIG. 20 shows a close-up view of an alternative embodiment of vehicle implement attachment system to be used with the present invention.

### DETAILED DESCRIPTION OF THE INVENTION

The invention is described with reference to an all-terrain vehicle (ATV). However, it should be understood that the features of this invention could be used with other vehicles such as, for example, a truck or tractor.

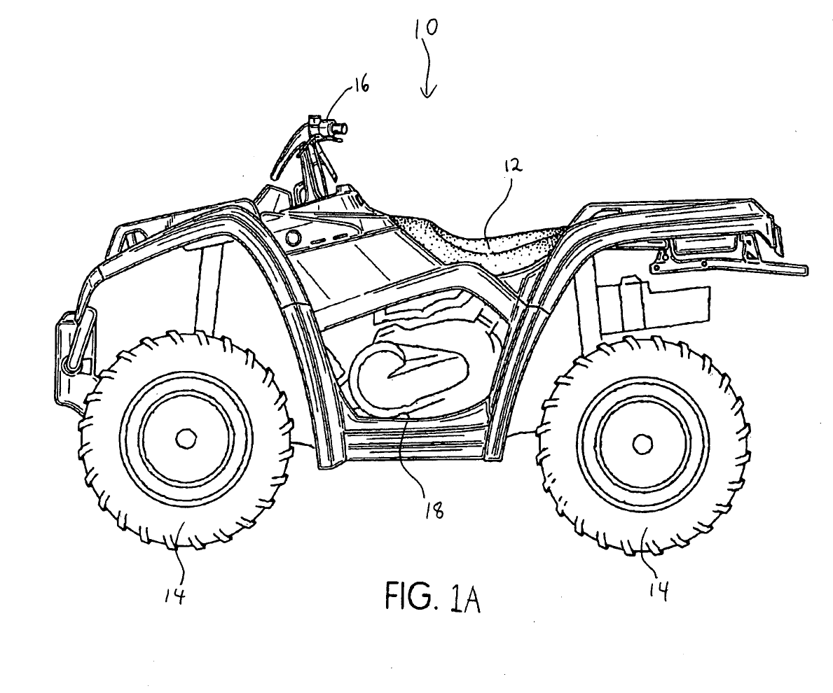

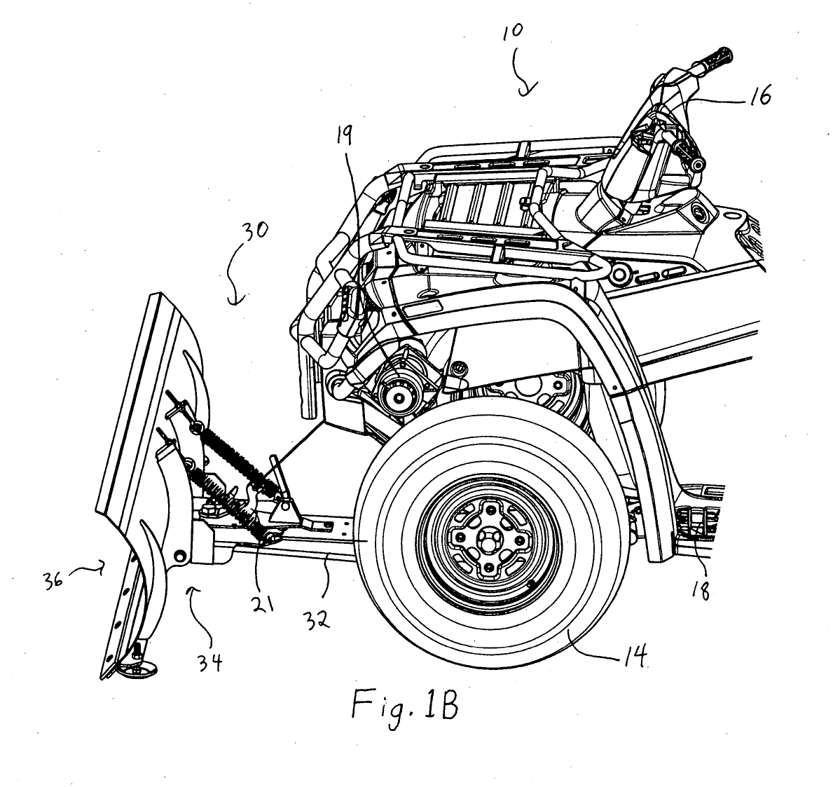

Referring to the figures, FIG. 1A illustrates an ATV 10 to which a vehicle implement 30 of the present invention can be attached. FIG. 1B illustrates the ATV 10 with the vehicle implement 30 attached thereto. The ATV 10 has a straddle-type seat 12 to accommodate a driver, and is some cases, a passenger as well. The ATV has four wheels 14: two in the front and two in the back. A set of handle bars 16 allows the driver to turn the front wheels 14 in order to steer the ATV 10. A footrest 18 is located on each side of the straddle-type seat 12 to accommodate the feet of the driver. A winch 19 (FIG. 1B) is provided on the front of the ATV 10 to haul loads without having to move the ATV 10. As will become apparent from the description below, the vehicle implement 30 can easily be attached and detached from the ATV 10. This way, the rider can easily switch from using the ATV 10 for leisurely riding to using it for doing work.

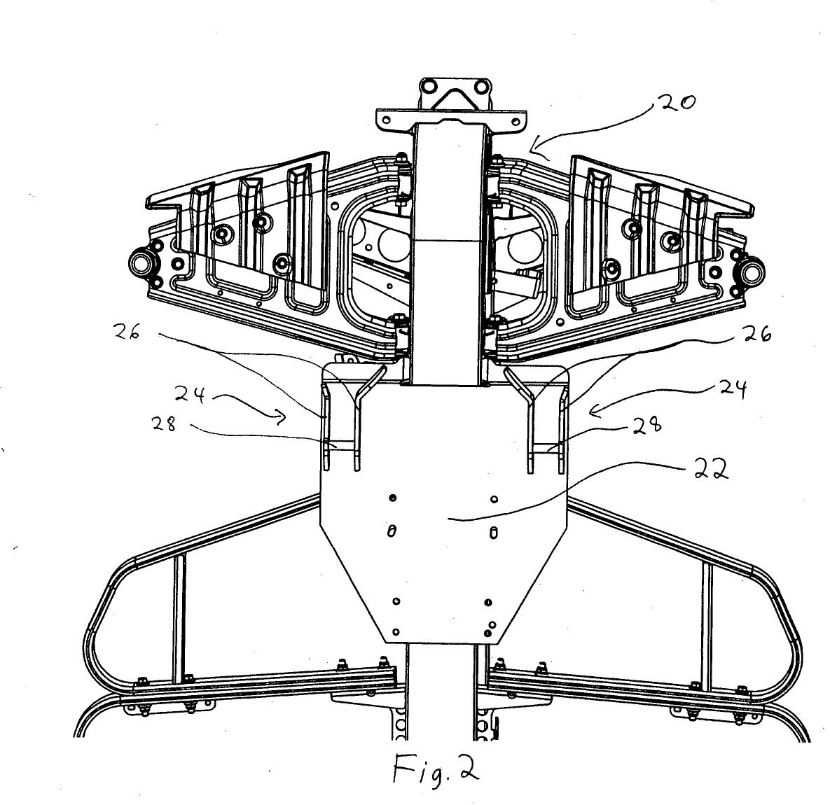

The ATV 10 has a frame 20 (FIG. 2) to which the various components of the ATV 10 are connected. A bracket 22 is connected to a bottom of the frame 20. The bracket 22 has a pair of second portions of the locks 24 to which the vehicle implement 30 will be attached. Each second portion of the lock 24 consists of a pair of flanges 26 with a pin 28 extending horizontally therebetween. The forward portions of the flanges 26 are flared outwardly so as to laterally align the vehicle implement 30 when the ATV 10 is moved to a vehicle implement engagement position, as will be described in greater details below.

It should be noted that other types of second portions of the locks 24 are also contemplated. For example, a single pair of flanges 26 disposed on either side of the bracket 22 with a single pin 28 spanning the width of the bracket 22 could be used.

The second portion of the lock 24, together with the first portion of the lock 102 or 246, described below, form a lock that is used to attach the vehicle implement 30 onto the ATV 10.

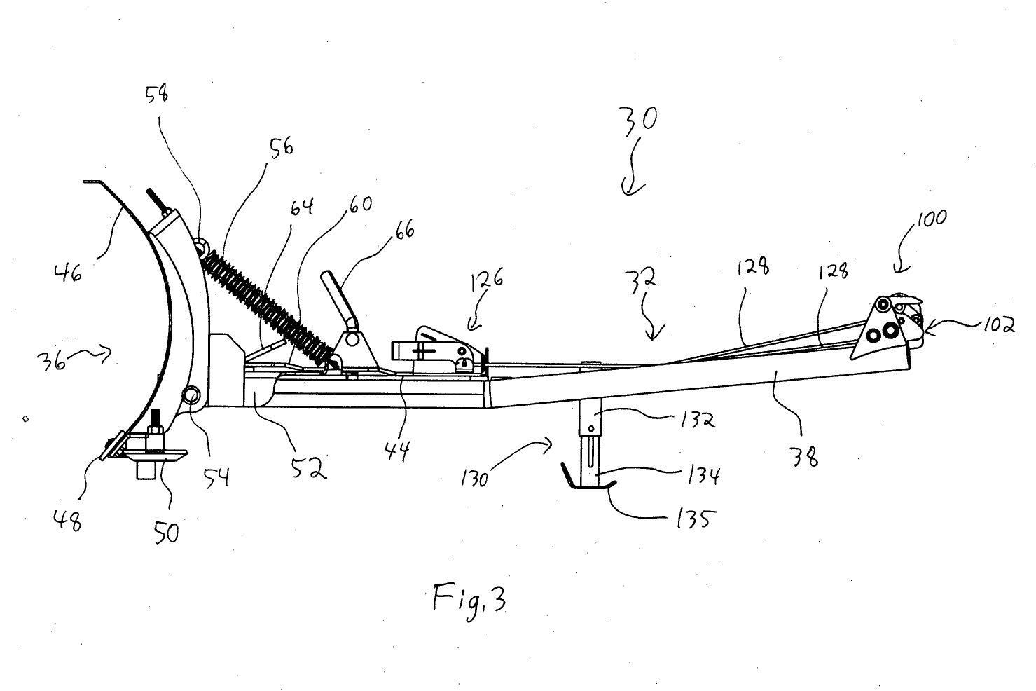

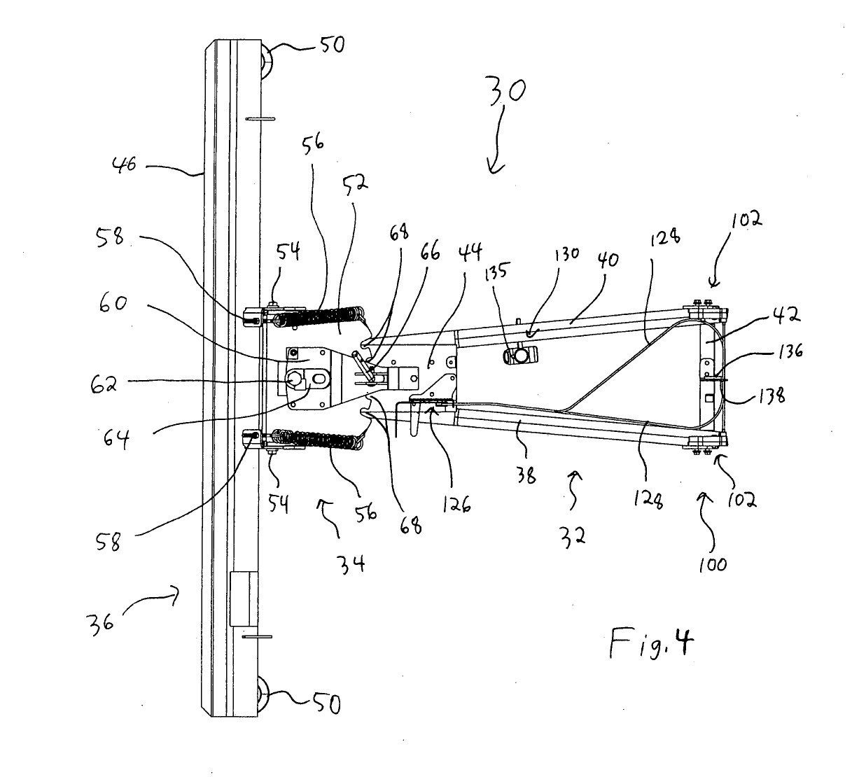

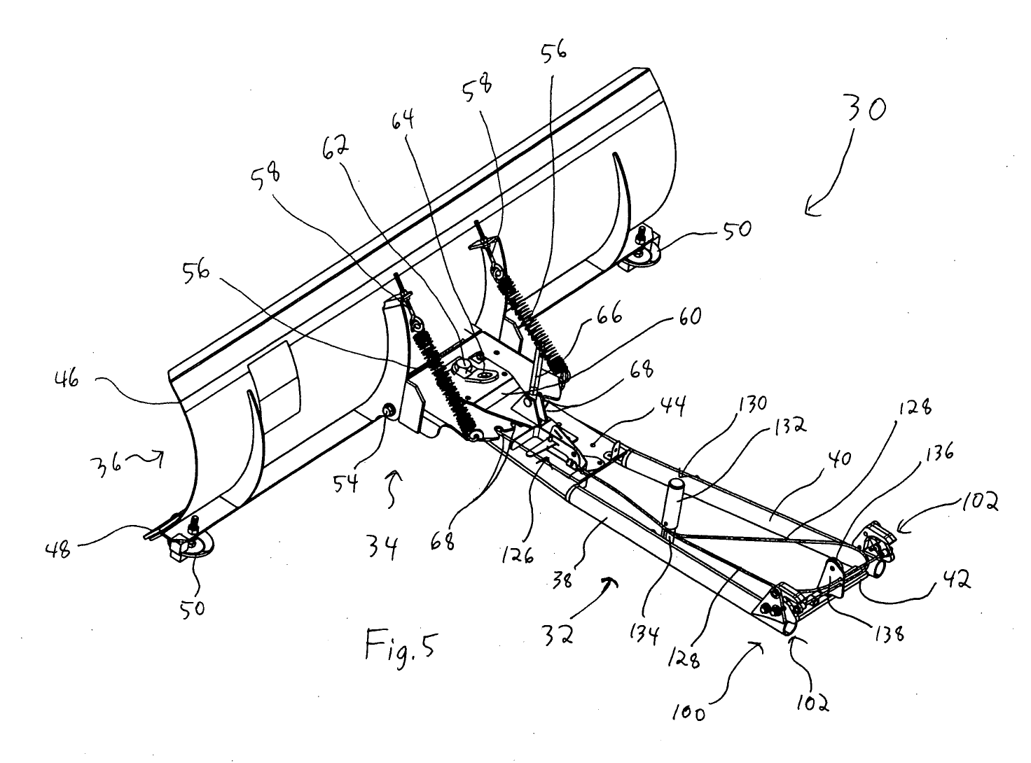

Turning now to FIGS. 3 to 5, the vehicle implement 30 having a first embodiment of the invention consists of a frame 32 having a utility attachment 34 at one end and a locking mechanism 100 at the other end.

The frame 32 is made of two tubular member 38, 40. A cross-member 42 is welded between the two tubular members 38, 40 at the end of the frame 32 where the locking mechanism 100 is located. A plate 44 is attached between the two tubular members 38, 40 at the other end of the frame 32. It should be understood that this construction of the frame 32 is only one possible embodiment and that other constructions are possible without deviating from the present invention.

The invention is described as having a utility attachment 34 in the form of a plow 36 attached to the front of the frame 32. It should be understood that features of this invention could be used with other types of utility attachments such as, for example, lawnmower attachments, tillers, and rollers, depending of the desired type of application.

The plow 36 has a curved blade 46. A scraper blade 48 is fastened to the bottom of the blade 46. The scraper blade 48 digs into the ground or snow and forces it onto the curved blade 46. A pair of sliders 50 are provided on either sides of the plow 36. The sliders 50 slide on the ground to prevent premature wear of the scraper blade 48.

The curved blade 46 is connected to a swivel plate 52 by bolts 54. A pair of springs 56 extend from a pair of threaded anchors 58, which are attached the top of the curved blade 46, to the swivel plate 52. The threaded anchors 58 allow for the adjustment of the tension in the springs 56. The springs 56 maintain the curved blade 46 in an upright position. When the scraper blade 48 hits an obstacle while in use, the curved blade 46 pivots about bolts 54 and the bias of the springs 56 returns the curved blade 46 to its original upright position after passing the obstacle.

The swivel plate 52 is located between plate 44 and a swivel retaining plate 60. The swivel retaining plate 60 is fastened onto the plate 44. A bolt 62 passes through the swivel retaining plate 60, the swivel plate 52 and plate 44 so as to retain the swivel plate 52 between the two plates 60, 44. The swivel plate 52 can swivel about bolt 62 such that the curved blade 46 can be skewed relative to the ATV 10. A hooking bracket 64 having a hole therein can receive the hook 21 (see FIG. 1B) of the winch 19. This permits the front of the frame 32 to be raised by using the winch 19.

A swivel lock 66 pivotally attached to swivel retaining plate 60 is used to lock the swivel plate 52 in a specific position by engaging one of a plurality of notches 68 on the swivel plate 52. To change the angle of the swivel plate 52, a user simply has to disengage the swivel lock 66, rotate the swivel plate 52 to the desired position, and engage the swivel lock 66 in the corresponding notch 68. By having the curved blade 46 skewed relative to the ATV 10, the earth or snow being plowed will be pushed to one side of the ATV 10 as the ATV 10 moves forward.

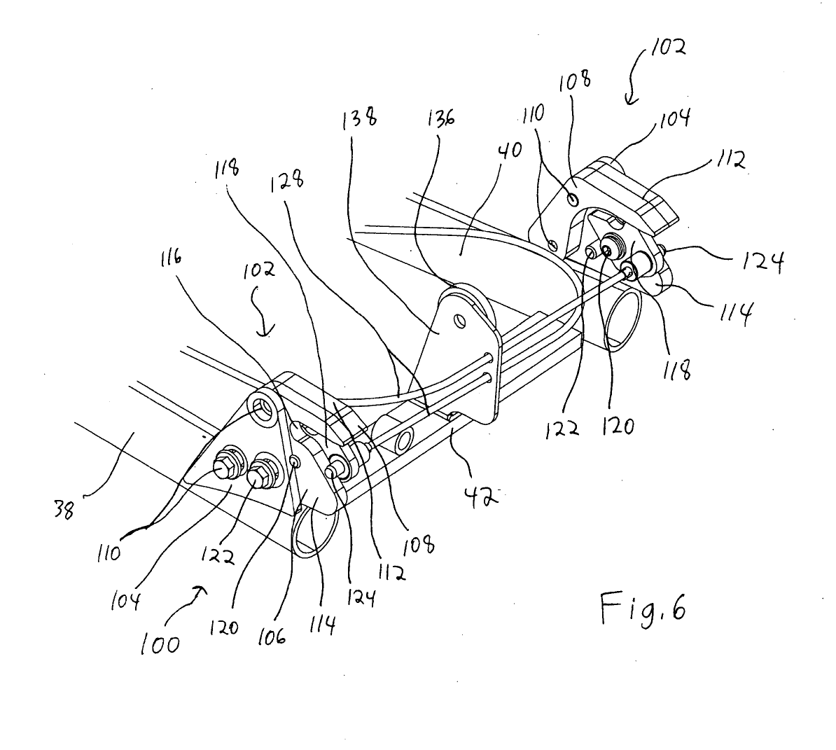

As previously mentioned, a locking mechanism 100 is attached to the end of the frame 32 opposite to the utility attachment 34. As best seen in FIG. 6, the locking mechanism comprises two first portions of the locks 102 affixed to the end of the tubular members 38 and 40. Each first portion of the lock 102 has a bracket 104 welded to its respective tubular member 38 or 40. A first and second fixed member, 106 and 108 respectively, are bolted together onto the bracket 104 by fasteners 110. Both fixed members 106 and 108 have an identical finger-like projection 112 at the upper ends thereof. The first fixed member 106 also has a lower projection 114, thus creating a notch 116 between the lower projection 114 and the finger-like projection 112. A locking element 118 is fastened to the lower projection 114 by fastener 120. The locking element 118 can rotate about the fastener 120. Another fastener 122 passing through the lower projection 114 acts as a stopper to limit the rotation of the locking element 118.

FIGS. 3 to 6 show the first portions of the locks 102 in a locked position In the locked position, the locking elements 118 abut fasteners 122 and close the notches 116. Spring-loaded pins 124 passing through the locking elements 118 prevent the locking elements 118 to move to an open position as they abut against the lower projections 114. The spring-loaded pins 124 are linked to a lever 126, which is located on the plate 44, via cables 128. Actuating the lever 126 causes the spring-loaded pins 124 to retract such that they no longer contact the lower projections 114, causing the locking elements 118 to rotate to an unlocked position.

A stand assembly 130 is attached to the right tubular member 40, near the longitudinal center thereof, inside frame 32. The stand assembly 130 supports the frame 32 above the ground when it is not attached to the ATV 10. The height of the stand assembly 130 can be modified to adjust the height of the frame 32 above the ground for reasons that will be explained in greater details below.

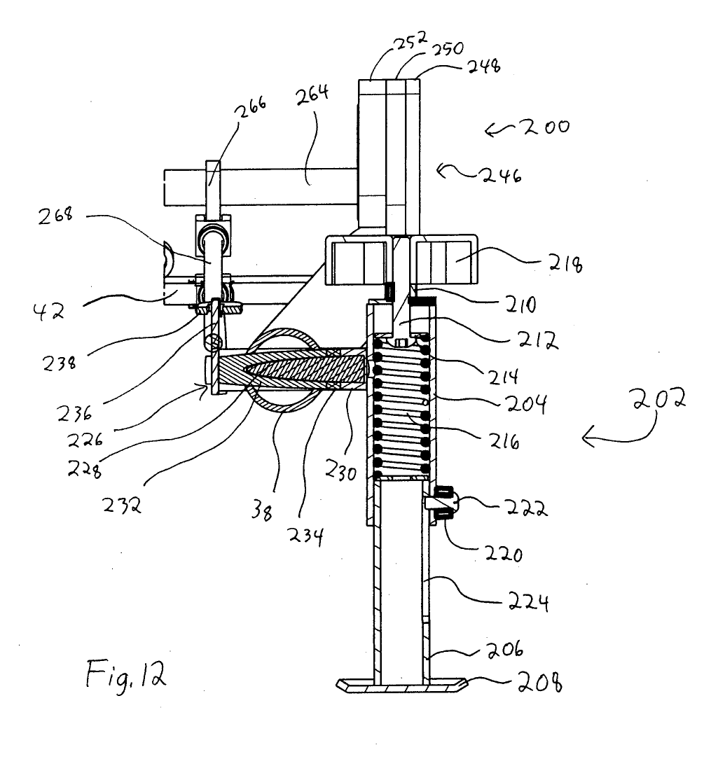

The stand assembly 130 is similar to stand assembly 202 shown in FIG. 12. It consists of a first tube 132 and a second tubes 134 having a foot 135, which together form a stand. Second tube 134 slideably fits inside first tube 132. A spring (not shown) is located inside the stand assembly 130 between the first and second tubes 132, 134. The spring and slideable tubes configuration of the stand assembly 130 allow it to compress upon the application of a downward load on the frame 32. Such a load would be applied by the ATV 10 as it makes contact with roller 136, which is connected to cross-member 42 via bracket 138, when the ATV 10 is moving into a vehicle implement engagement position, as will be explained below.

To attach the vehicle implement 30 to the ATV 10, they first have to be roughly lined up with each other. The height of the stand assembly 130 is then adjusted such that the notches 116 in the locking mechanism are as high or higher than pins 28 of the second portions of the locks 24. The alignment of notches 116 and pins 28 does not have to be exact. As long as the vehicle implement 30 and the ATV 10 are located on roughly even surfaces when being attached to each other, this step will not have to be repeated from one use to the other since the present invention provides for some variations in height between the vehicle implement 30 and the ATV 10.

Then, the locking mechanism 100 needs to be unlocked in the manner described above, if it is not already in that position. The ATV 10 is then moved towards the vehicle implement 30 into what is described in this application as a vehicle implement engagement position. As the ATV 10 moves towards the vehicle implement 30, if the notches 116 are too high relative to pins 28, the frame 20 of the ATV 10 will push down on roller 136, thus compressing stand assembly 130, so as to line up notches 116 and pins 28. It will be understood that the position of the top of roller 136 is selected to provide such an alignment. Also, if the vehicle implement 30 and the ATV 10 are not properly aligned laterally, the bent portions of the flanges 26 will come in contact with the first portions of the locks 102 to properly align them as the ATV 10 moves forward.

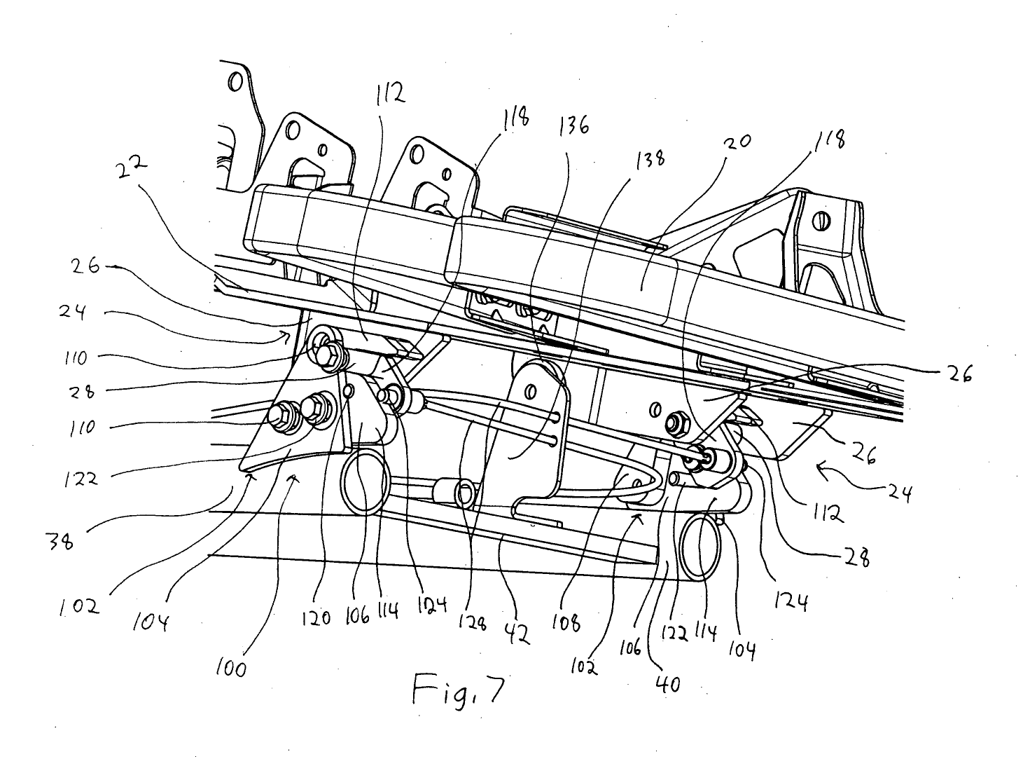

Finally, as shown in FIG. 7, when the pins 28 enter notches 68 in the vehicle implement engagement position, the pins 28 cause the locking elements 118 to rotate to a locked position. The vehicle implement 30 is now attached to the ATV 10. The pins 124 prevent pins 28 from being pulled out of notches 116 should the ATV 10 move backwards.

Once the vehicle implement 30 is attached to the ATV 10, the utility attachment 34 can be raised or lowered as the vehicle implement 30 is free to rotate about pins 28. One way to do this is by attaching the hook 21 of the winch 19 to the hooking bracket 104, as shown in FIG. 1B, and reeling the winch wire in or out until the utility attachment 34 is at the desired height.

To detach the vehicle implement 30 from the ATV 10, the utility attachment 34 needs to first be lowered to the ground if it is not already in that position. Then, the locking mechanism 100 needs to be unlocked by moving the lever 126 to release pins 124, as previously described. Finally, the ATV 10 simply needs to back up.

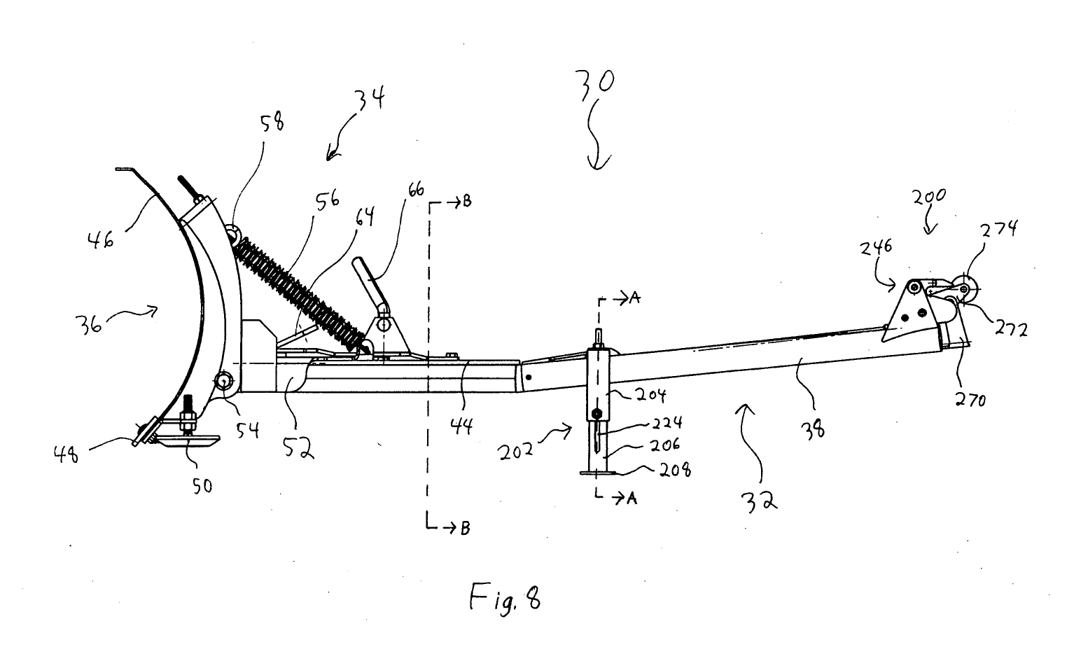

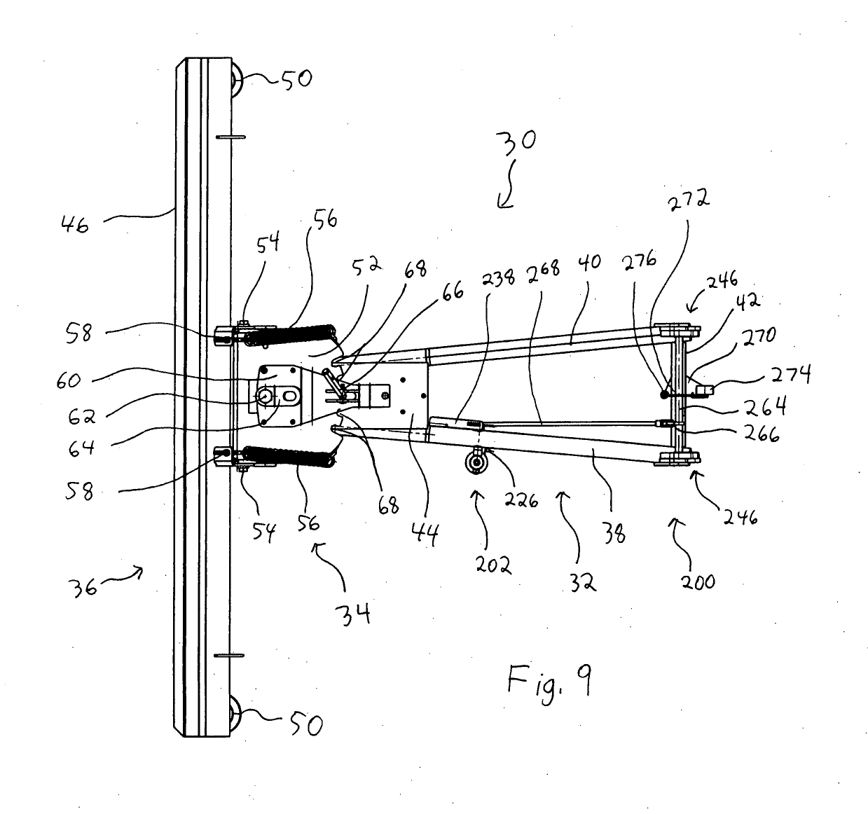

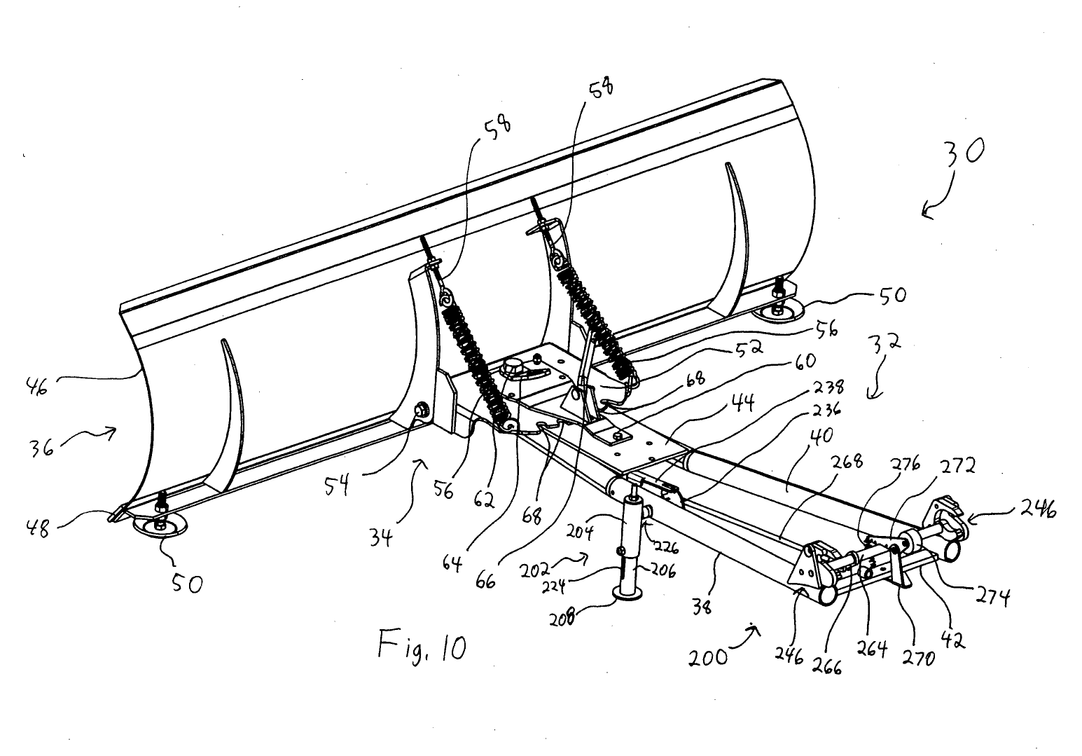

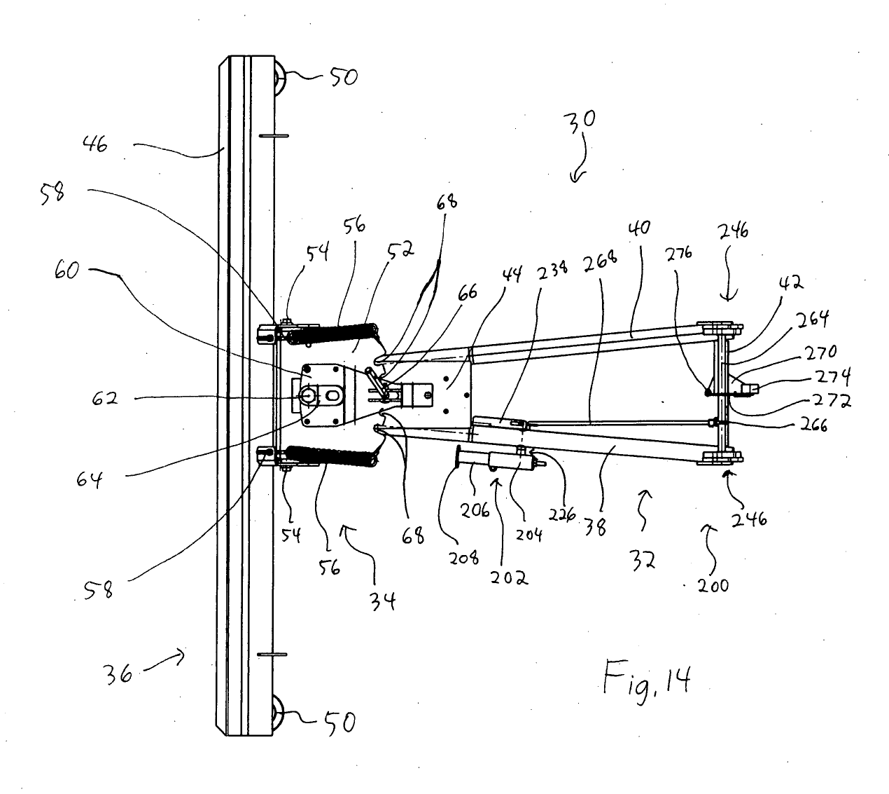

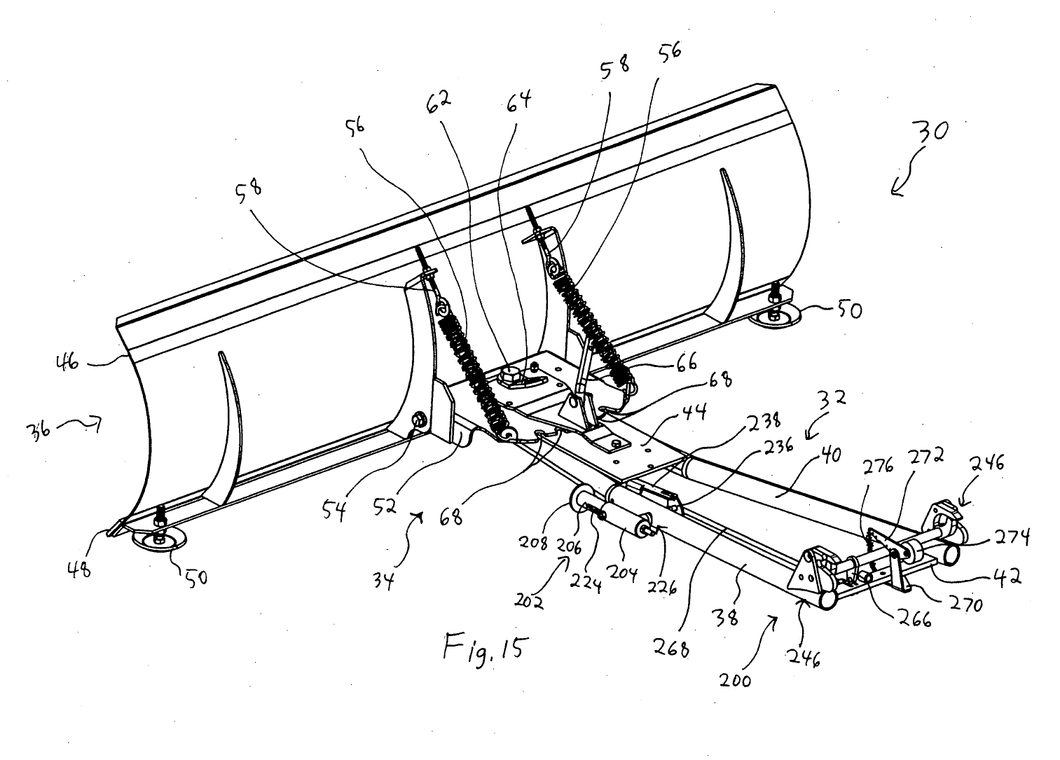

A second embodiment of the present invention is illustrated in FIGS. 8 to 19. The vehicle implement 30 having the second embodiment has a similar frame 32 and utility attachment 34 as the ones shown in relation with the first embodiment and the components thereof have been labelled with the same reference numerals as those used in relation with the first embodiment. They will therefore not be described again.

The second embodiment has a locking mechanism 200 which is actuated by a stand assembly 202.

As best seen if FIG. 12, the stands assembly 202 consists of a first tube 204 and a second tube 206, having a foot 208, which fits inside the first tube 204, which together form a stand. A threaded nut 210 is welded to the top of the first tube 204. A bolt 212, having a circular plate 214 welded to a head thereof, is screwed in nut 210 such that the head of the bolt 212 and the circular plate 214 are located inside the first tube 204. A spring 216 is provided inside the stand assembly 202 between the top of the second tube 206 and the circular plate 214. This allows the stand assembly 202 to be compressed upon the application of a downward load on the frame 32. By turning a handle 218 (not shown in the other figures) provided at the end of the bolt 210, which turns bolt 210, the height of the stand assembly 202, and thus the height of the frame 32 above the ground, can be adjusted. Another threaded nut 220 is welded to the side of the first tube 204. A fastener 222, screwed in the nut 220, extends inside a slot 224 in the second tube 206. This prevents the second tube 206 from coming out of the first tube 204 and also guides the first tube 204 over the second tube 206 as the stand assembly 202 is being compressed.

The stand assembly 202 is rotatably connected to the left tubular member 38 on the outside of frame 32 via pivot assembly 226. One end of the pivot assembly 226 is welded to the first tube 204 and the second end of the pivot assembly 226 passes through and rotates inside the left tubular member 38. The pivot assembly 226 consists of a central rod 228 with first and second bushing 230, 232 fitted thereon such that they rotate together. A washer 234 is also disposed about rod 228 and is welded to the left tubular member 38 to prevent lateral movement of the pivot assembly 226. The rod 228 can rotate inside washer 234. A locking plate 236 is attached to the end of the pivot assembly 226 and rotates with it.

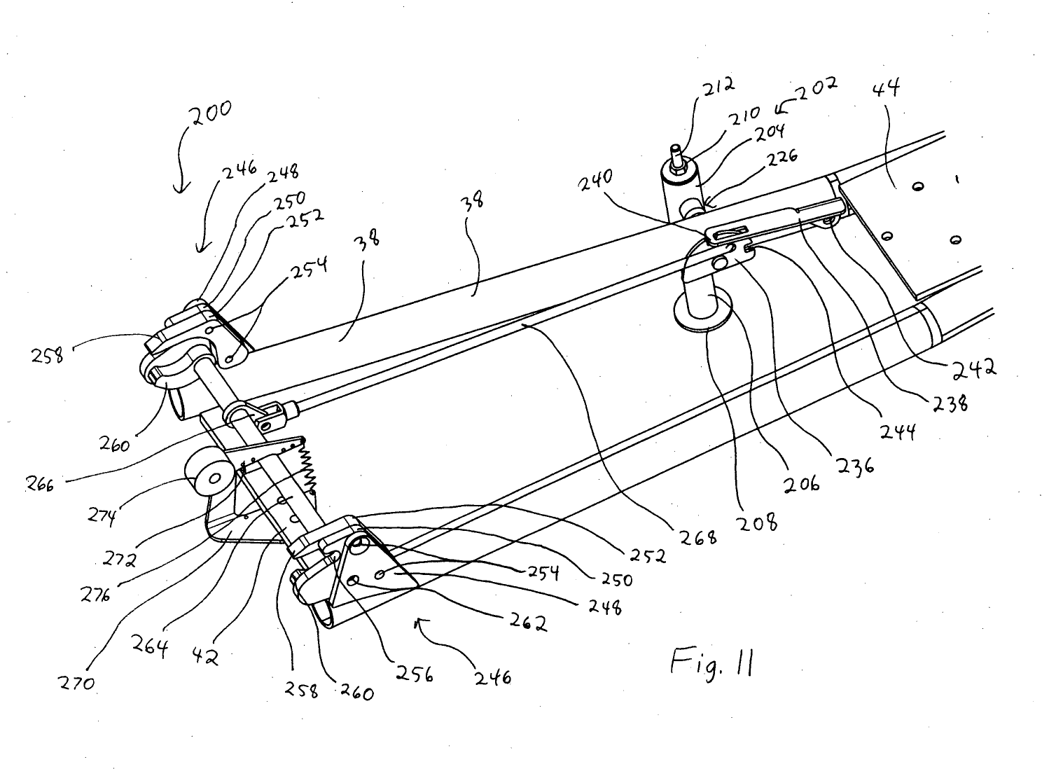

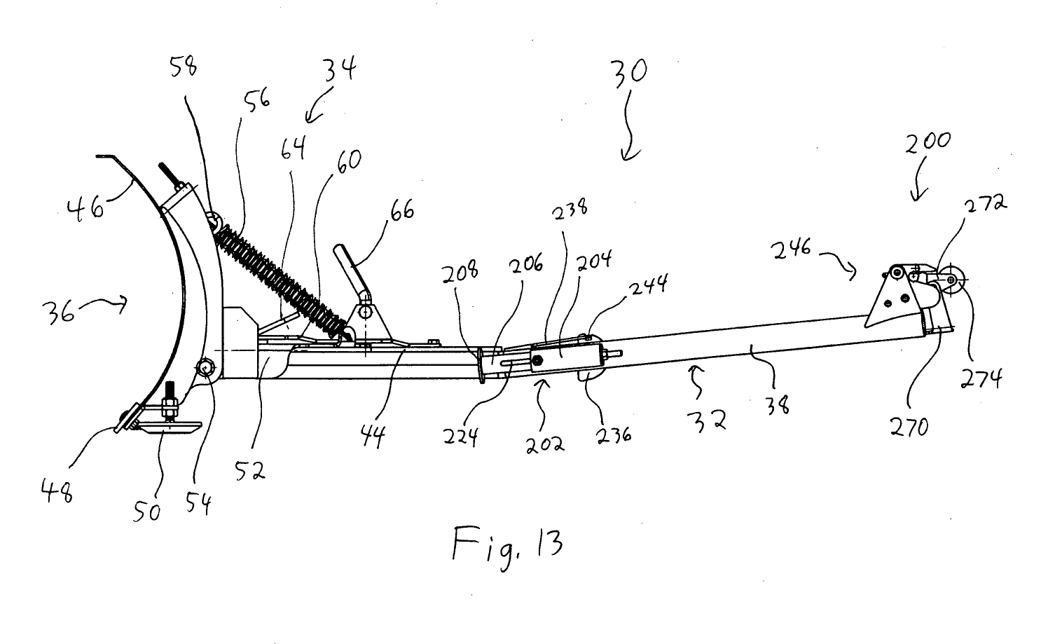

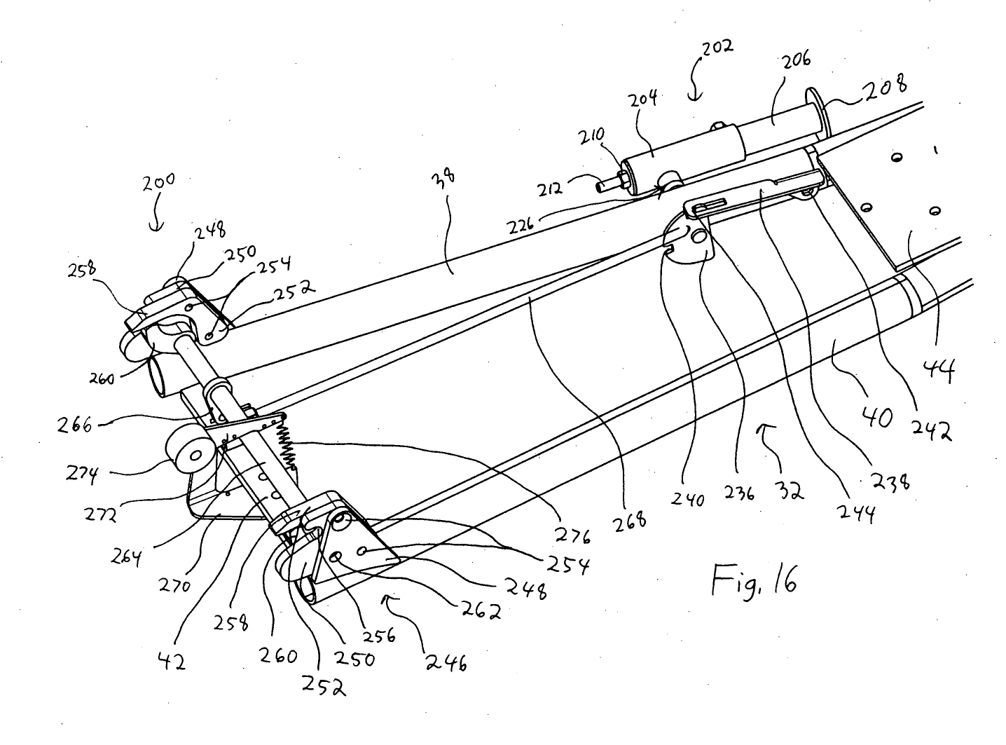

FIGS. 8 to 12 show the stand assembly 202 in a first position supporting the frame 32. When in the first position, the stand assembly is locked in place by locking arm 238 which engages a first notch 240 in locking plate 236 as best seen in FIG. 11. The locking arm 238 pivots about fastener 242, which attaches it to the left tubular member 38, and is biased by a spring (not shown) towards the locking plate 236. To rotate the stand assembly 202 to a second position where it is stowed away, as shown in FIGS. 13 to 16, the locking arm 238 is first lifted to disengage the first notch 240. The stand assembly 202 is then rotated until the locking arm 238 engages a second notch 244 in locking plate 236, as best seen in FIG. 16. The same procedure is used to move the stand assembly 202 back to the first position.

As previously mentioned, a locking mechanism 200 is attached to the end of the frame 32 opposite to the utility attachment 34. As best seen in FIGS. 11 and 16, the locking mechanism comprises two first portions of the locks 246 affixed to the end of the tubular members 38 and 40. Each first portion of the lock 246 has a bracket 248 welded to its respective tubular member 38 or 40. A first and second fixed member, 250 and 252 respectively, are bolted together onto the bracket 248 by fasteners 254. It is contemplated that first and second fixed member 250, 252, could be a combined into a single fixed member. Fixed members 250 have a notch 256 therein to receive pins 28 of the second portion of the lock 24. Fixed members 252 have a finger-like projection 258 at the upper ends thereof. Locking elements 260 are fastened to fixed members 250 by fasteners 262. The locking elements 260 can rotate about the fasteners 262.

A rod 264 extends from one locking element 260 to the other such that when the rod 264 rotates, both locking elements 260 rotate with it. An arm 266 is connected to the rod 264. A connecting rod 268 is pivotally connected at one end to the arm 266 and at the other end to the locking plate 236. This linkage allows the first portions of the locks 246 to be actuated by the stand assembly 202 as described below.

When the stand assembly 202 is moved to its second, stowed away position as described above, the rotation of the locking plate 236 causes the connecting rod 268 to push on arm 266. This causes rod 264 to rotate, which rotates the locking elements 260 to a locked position as shown in FIGS. 13 to 16. When the stand assembly 202 is moved back to its first, frame supporting position as described above, the rotation of the locking plate 236 causes the connecting rod 268 to pull on arm 266. This causes rod 264 to rotate the other way, which rotates the locking elements 260 to an unlocked position as shown in FIGS. 8 to 11.

A bracket 270 is connected to the cross-member 42. The bracket 270 supports a pivot arm 272. The pivot arm 272 has a roller 274 attached at one end thereof and a spring 276 at the other. The spring 276 extends from the pivot arm 272 back to the bracket 270. Spring 276 has a spring constant which is greater than the spring constant of spring 216 of the stand assembly 202. The reason for this arrangement will become apparent in the explanation provided below.

To attach the vehicle implement 30 to the ATV 10, the locking mechanism 200 first needs to be unlocked by moving the stand assembly 202 to its first, frame supporting position as described above, if it is not already in that position. Then, the vehicle implement 30 and the ATV 10 have to be roughly lined up with each other. The height of the stand assembly 202 is then adjusted such that the notches 256 in the locking mechanism are as high or higher than pins 28 of the second portions of the locks 24. Once again, the alignment of notches 256 and pins 28 does not have to be exact. As long as the vehicle implement 30 and the ATV 10 are located on roughly even surfaces when being attached to each other, this step will not have to be repeated from one use to the other as the present invention provides for some variations in height between the vehicle implement 30 and the ATV 10.

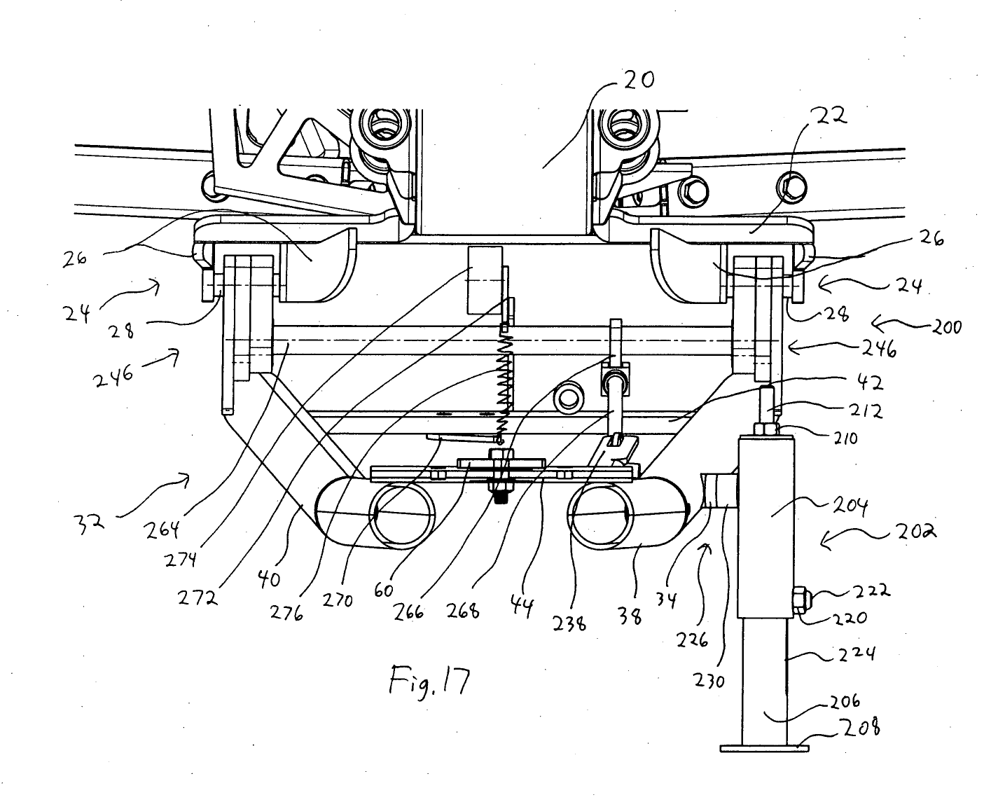

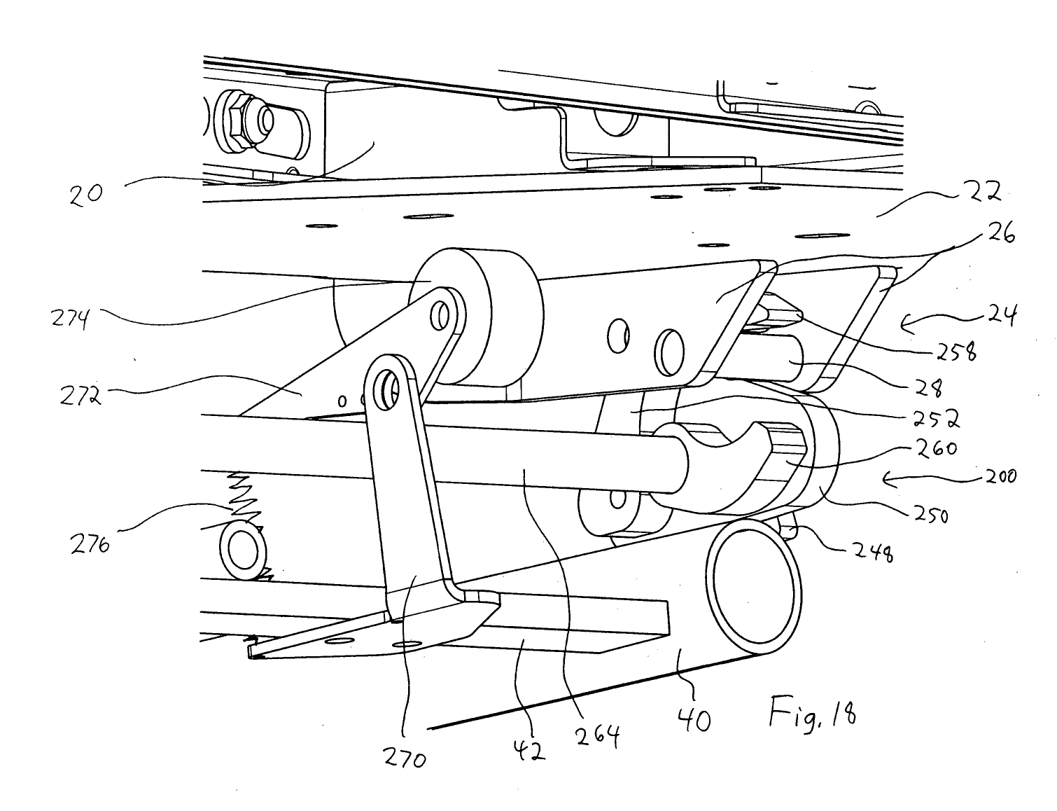

The ATV 10 is then moved towards the vehicle implement 30 into what is described in this application as a vehicle implement engagement position. As the ATV 10 moves towards the vehicle implement 30, if the notches 256 are too high relative to pins 28, the frame 20 of the ATV 10 will push down on roller 274. Since spring constant of spring 276 is greater than the spring constant of spring 216 of the stand assembly 202, the roller 274 does not move relative to notches 256 and it is the stand assembly 202 that is compressed. This causes notches 256 to line up with pins 28, as shown in FIG. 18. It will be understood that the position of the top of roller 274 is selected to provide such an alignment. Also, if the vehicle implement 30 and the ATV 10 are not properly aligned laterally, the bent portions of the flanges 26 will come in contact with the first portions of locks 246 to properly align them as the ATV 10 moves forward, as shown in FIG. 17.

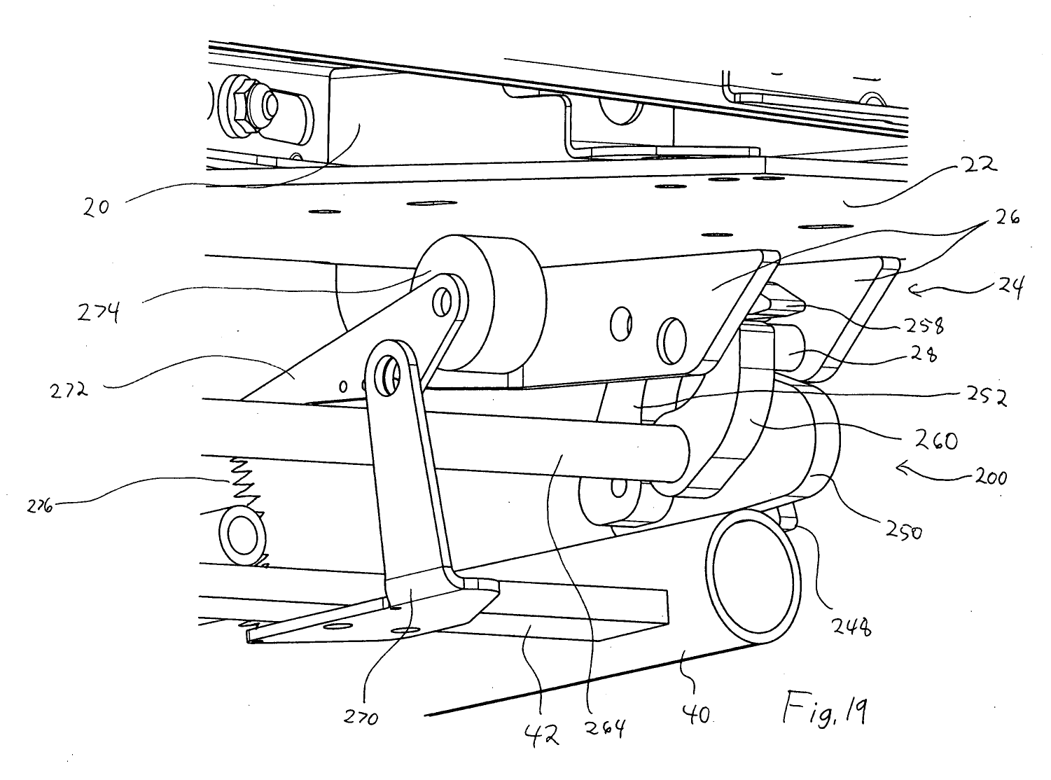

Once the pins 28 are engaged in the notches 256, as shown in FIG. 18, the hook 21 of the winch 19 is hooked to hooking bracket 64 and the winch wire is reeled in to lift the utility attachment 34 slightly off the ground. This temporarily prevents the pins 28 to slide out of notches 256 and also lifts the stand assembly 202 off the ground which facilitates the next step. The next, and final step consists in locking the locking mechanism 200 by moving the stand assembly 202 to its second, stowed away position as described above. As shown in FIG. 19, the vehicle implement 30 is attached to the ATV 10.

Once the vehicle implement 30 is attached to the ATV 10, the utility attachment 34 can be raised or lowered by using the winch 19 as the vehicle implement 30 is free to rotate about pins 28.

When in use, should the lowest part of the utility attachment 34 become lower than the front wheels 14 of the ATV 10, such as when coming off of a sidewalk, the roller 270 and pivot arm 272 arrangement will allow the frame 32 to rotate downwardly. The spring 276 controls this movement, and as mentioned previously, prevents the pivot arm 272 to pivot when the vehicle implement 30 is attached to the ATV 10.

To detach the vehicle implement 30 from the ATV 10, the locking mechanism 200 needs to be unlocked by moving the stand assembly 202 back to its first, frame supporting position, as previously described. Then, the utility attachment 34 needs to be lowered to the ground, and the hook 21 of the winch 19 needs to be unhooked from the hooking bracket 64. Finally, the ATV 10 simply needs to back up.

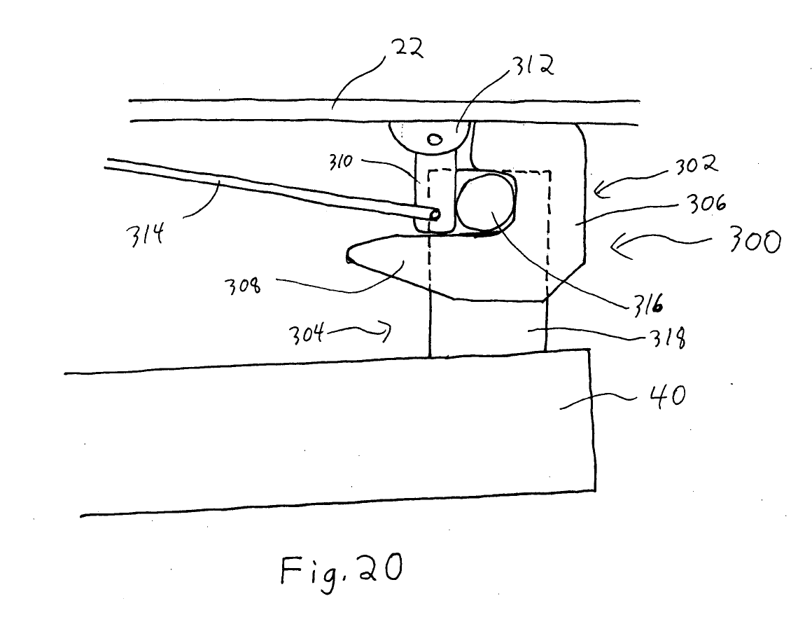

FIG. 20 shows an alternative embodiment of a locking mechanism 300 that could be used with the present invention. In this embodiment, the second portion of the lock 302 is attached to the bracket 22 found on the ATV 10 and first portion of the lock 304 is attached to the frame 32. The second portion of the lock 302 has a fixed member 306, having a finger-like projection 308, welded to bracket 22. A locking element 310 pivots about flange 312 to lock and unlock the second portion of the lock 302. The locking element is actuated by rod 314. The first portion of the lock 304 has a pin 316 attached to a tubular frame member, tubular frame member 40 in FIG. 20, via a bracket 318. A vehicle implement 30 and ATV 10 using such a locking mechanism would be attached to each other in a method similar to those described previously.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A vehicle implement attachment assembly for attaching a vehicle implement to a vehicle, the assembly comprising:
a frame having a first end and a second end, the first end being constructed and arranged to cooperate with a utility attachment;
a lock having a first portion and a second portion, the first portion of the lock being operatively connected to the second end of the frame, the second portion of the lock being disposed on the vehicle, the first portion of the lock being constructed and arranged to cooperate with the second portion of the lock; and
a stand assembly disposed on the frame, for supporting the frame at a variable height above the ground when the utility attachment is attached to the frame, the height of the stand assembly diminishing at least in response to movement of the vehicle to a vehicle implement engagement position.

2. The vehicle implement of claim 1, wherein the stand assembly comprises a stand and a spring attached to the stand.

3. The vehicle implement of claim 2, wherein the height of the stand assembly is adjustable.

4. The vehicle implement of claim 1, wherein the stand assembly is moveable between a first position supporting the frame and a second position where the stand assembly is stowed away.

5. The vehicle implement of claim 4, wherein the stand assembly is rotatable between the first and the second positions.

6. The vehicle implement of claim 4, wherein:
the stand assembly is operatively connected to the first portion of the lock such that moving the stand assembly to the first position unlocks the lock and moving the stand assembly to the second position locks the lock.

7. The vehicle implement of claim 2, further comprising a miller operatively connected to the second end of the frame and adapted for receiving a downward force as the vehicle moves to the vehicle implement engagement position.

8. The vehicle implement of claim 1, further comprising the utility attachment operatively connected to the first end of the frame.

9. The vehicle implement of claim 8, wherein the utility attachment is pivotally connected to the first end of the frame.

10. The vehicle implement of claim 8, wherein the utility attachment is a plow.

11. A vehicle implement attachment assembly for attaching a vehicle implement to a vehicle, the assembly comprising:
a frame having a first end and a second end, the first end being constructed and arranged to cooperate with a utility attachment;
a lock having a first portion and a second portion, the first portion of the lock being operatively connected to the second end of the frame, the second portion of the lock being disposed on the vehicle, the first portion of the lock being constructed and arranged to cooperate with the second portion of the lock; and
a stand assembly operatively connected to the frame, the stand assembly being moveable between a first position supporting the frame and a second position where the stand assembly is stowed away, the stand assembly being operatively connected to the first portion of the lock such that moving the stand assembly to the first position unlocks the lock and moving the stand assembly to the second position locks the lock.

12. The vehicle implement of claim 11, wherein the stand assembly is rotatable between the first and the second positions.

13. The vehicle implement of claim 12, further comprising another lock connected to the frame for locking the stand assembly in the first and the second positions.

14. The vehicle implement of claim 11, further comprising a utility attachment operatively connected to the first end of the frame.

15. The vehicle implement of claim 14, wherein the utility attachment is pivotally connected to the first end of the frame.

16. The vehicle implement of claim 14, wherein the utility attachment is a plow.

17. A method for attaching a vehicle implement to a vehicle,
the vehicle implement having:
a frame having a first end and a second end;
a utility attachment operatively connected to the first end;
a first portion of a lock operatively connected to the second end; and
a stand assembly operatively connected to the frame for supporting the frame when the vehicle implement rests on the ground when the stand assembly is in a first position;
the vehicle having:
a bracket attached to a portion thereof; and
a second portion of the lock being attached to the bracket;
the method comprising the steps of:
adjusting the height of the stand assembly when the stand assembly is in the first position, such that the first portion of the lock is at least as high above the ground as the second portion of the lock;
moving the vehicle to a vehicle implement engagement position;
vertically aligning the first portion of the lock with the second portion of the lock by causing the vehicle to lower the second end of the frame as the vehicle moves into the vehicle implement engagement position; and
locking the lock.

18. The method of claim 17, further comprising the step of raising the first end of the frame prior to locking the lock.

19. The method of claim 18, wherein the step of raising the first end of the frame is accomplished by attaching a winch wire of a winch of the vehicle to the first end of the frame and at least partially reeling in the winch wire.

20. The method of claim 17, wherein:
the stand assembly has a stand and a spring attached to the stand, and
the step of vertically aligning the first portion of the lock with the second portion of the lock comprises the step of compressing the stand assembly when the vehicle is caused to lower the second end of the frame as the vehicle moves into the vehicle implement engagement position.

21. The method of claim 17, wherein:
the stand assembly is operatively connected to the first portion of the lock, and
the step of locking the lock is achieved by moving the stand assembly from the first position to a second position where the stand assembly is stowed away.

22. The method of claim 21, wherein the stand assembly is rotated between the first and second positions.

23. The method of claim 17, further comprising the step of laterally aligning the portion of the lock and the second portion of the lock by moving the vehicle to a vehicle implement engagement position.
